(19) United States
(12) Patent Application Publication
(10) Pub. No.: US 2007/0178311 A1
(43) Pub. Date: Aug. 2, 2007

(54) Method to produce coated film

(75) Inventor: Kiyoshi Akagi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/655,582

(22) Filed: Jan. 19, 2007

(30) Foreign Application Priority Data
Jan. 30, 2006 (JP) JP2006-020627

(51) Int. Cl. B05D 7/00; B05D 1/36; B32B 9/04

(52) U.S. Cl. 428/411.1; 427/407.1

(57) ABSTRACT

A method to produce a coated film comprising the steps of: (a) ejecting a coating liquid continuously from an ejecting portion of an extrusion head; (b) applying the coating liquid ejected from the ejecting portion of the extrusion head onto a continuously conveyed film; and (c) stopping the ejection of the coating liquid, wherein an organic solvent is supplied to a vicinity of the ejecting portion of the extrusion head from before starting the ejection of the coating liquid to after starting the ejection of the coating liquid in step (a).

This application is based on Japanese Patent Application No. 2006-20627 filed on Jan. 30, 2006 in Japanese Patent Office, the entire content of which is hereby incorporated by reference.

### FIELD OF THE INVENTION

The present invention relates to a manufacturing method of a coated film having a coated layer formed by applying a coating liquid on the surface of a continuously running film to be coated by use of an extrusion head having an ejecting portion of a coating liquid.

### BACKGROUND OF THE INVENTION

Heretofore, there are various coating methods in a coating process to coat a coating liquid on a film to be coated. The coating method is roughly classified into two types. One is a pre-measurement type coating method to coat a coating liquid on a film to be coated by ejecting a coating liquid of as much quantity as required to form a coated layer on a film to be coated, and the other is a post-measurement type coating method, in which an excessive quantity of a coating liquid more than a quantity required to form a coated layer is ejected on a film to be coated and thereafter the excess portion is removed by a some scratching means. A post-measurement type coating method includes such as a blade type coating method, an air-knife type coating method and a wired-bar coating method. Further, a pre-measurement type coating method includes such as a coating method utilizing a slot type extrusion head, a coating method utilizing a curtain type coating head and a coating method utilizing a slide type coating head. Generally, in a pre-measurement type a highly precise coated layer can be prepared although such as the apparatus constitution is complex, while in a post-measurement type the precision of a coated solution layer is inferior to the former although such as the apparatus constitution is simple and the processing speed is fast. Further, since a pre-measurement type naturally consumes less quantity, when a pre-measurement type and a post-measurement type are compared with respect to a consumption quantity of a coating liquid, and is advantageous in manufacturing efficiency, a pre-measurement type has been more often employed. In the case of coating by means of such a pre-measurement coating method, particularly when a utilized coating liquid is an organic solvent type, drying is often caused at the ejecting portion to make a dried coating liquid adhere on the ejecting portion resulting in generation of uneven coating (streak defects). When a coating liquid adheres to generate uneven coating (streak defects), it is necessary to immediately stop coating and to restart coating after cleaning a coating head, which becomes one reason to decrease manufacturing efficiency.

With respect to a method to prevent drying of a coating liquid on a coating head, heretofore, many studies have been made. For example, described is a coating method in which an ejecting portion is wetted with a solvent until the start of coating by use of a solvent supply means at the time of coating employing an extrusion head, and supply of the solvent is stopped immediately before coating (for example, refer to patent literature 1.). Further, described is a coating method in which an ejecting portion is wetted with a solvent until the start of coating by use of a solvent supply means at the time of coating employing an extrusion head, supply of the solvent being stopped immediately before coating and a solvent is supplied to the vicinity of the ejecting portion by use of a solvent supply means nearly simultaneously with the stop of coating (for example, refer to patent literature 2.).

However, in the case of coating methods described in patent literatures 1 and 2, there is a problem of supply timing of an organic solvent to the vicinity of an ejecting portion. That is, it is described that an organic solvent is supplied until before the start of coating or nearly simultaneously after the stop of coating, and the supply of an organic solvent is stopped immediately before the start of coating while an organic solvent is kept flowing during non-coating time; however, this timing may provide time when organic solvent is not supplied to the ejecting portion of the extrusion head, resulting in risk of drying of a coating liquid at the ejecting portion. This is because it takes time to arrive the organic solvent supplied to the vicinity of the ejecting portion to the ejecting portion of the extrusion head (since the organic solvent cannot be supplied directly to the ejecting portion, it must be supplied to the vicinity of the ejecting portion).

In view of such a situation, development of a manufacturing method of a coated film, in which adhesion of a coating liquid on the ejecting portion of an extrusion head to eject a coating liquid is prevented to achieve high manufacturing efficiency, has been desired.

[Patent Literature 1] JP-A No. 6-114318 (hereinafter, JP-A refers to Japanese Patent Publication Open to Public Inspection)

[Patent Literature 2] JP-A No. 7-108213

### SUMMARY OF THE INVENTION

A film of the present invention is to provide a manufacturing method of a coated film, in which adhesion of a coating liquid on an ejecting portion of an extrusion head, from which a coating liquid is ejected, is prevented and a high manufacturing efficiency is achieved.

One of the aspects of the present invention to achieve the above object is a method to produce a coated film comprising the steps of: (a)ejecting a coating liquid continuously from an ejecting portion of an extrusion head; (b) applying the coating liquid ejected from the ejecting portion of the extrusion head onto a continuously conveyed film; and (c) stopping the ejection of the coating liquid, wherein an organic solvent is supplied to a vicinity of the ejecting portion of the extrusion head from before starting the ejection of the coating liquid to after starting the ejection of the coating liquid in step (a).

### BRIEF DESCRIPTION OF THE DRAWINGS

FIG. 1 is a schematic drawing to show the state of coating on the surface of a film to be coated by use of a conventional extrusion head.

FIG. 2 is a schematic drawing of the extrusion head, which is shown in FIG. 1, equipped with a solvent supply means.

FIG. 3 is a schematic drawing of an extrusion head on which another solvent supply means are arranged.

FIG. 4 a schematic flow diagram of a manufacturing method of a coated film by use of an extrusion head 2 which employs a solvent supply means shown in FIG. 2.

### DESCRIPTION OF THE PREFERRED EMBODIMENTS

The above-described object of the present invention has been achieved by the following constitutions.

(1) A method to produce a coated film comprising the steps of:
(a) ejecting a coating liquid continuously from an ejecting portion of an extrusion head;
(b) applying the coating liquid ejected from the ejecting portion of the extrusion head onto a continuously conveyed film; and
(c) stopping the ejection of the coating liquid, wherein
an organic solvent is supplied to a vicinity of the ejecting portion of the extrusion head from before starting the ejection of the coating liquid to after starting the ejection of the coating liquid in step (a).

(2) The method-of Item (1), wherein
the organic solvent is supplied to the vicinity of the ejecting portion of the extrusion head from before stopping the ejection of the coating liquid to after stopping the ejection of the coating liquid in step (c).

(3) The method of Item (1) or (2), wherein
the organic solvent is supplied to the vicinity of the ejecting portion of the extrusion head from before starting the ejection of the coating liquid in step (a) to after starting the application of the coating liquid onto the continuously conveyed film in step (b).

(4) The method of any one of Items (1) to (3) further comprising the step of:
(d) moving the extrusion head away from the continuously conveyed film while the coating liquid is continuously ejected from the ejecting portion of the extrusion head.

(5) The method of Item (4), wherein
the organic solvent is supplied to the vicinity of the ejecting portion of the extrusion head from before step (d) to after step (d)

(6) The method of Item (4) or (5), subsequent to step (d), further comprising the step of:
(e) moving the extrusion head again to start applying the coating liquid onto the continuously conveyed film.

(7) The method of Item (6), wherein
the organic solvent is supplied to the vicinity of the ejecting portion of the extrusion head from before step (d) to after step (e)

(8) The method of any one of Items (1) to (7), after step (c), further comprising the step of:
(f) ejecting the coating liquid continuously again from the ejecting portion of the extrusion head.

(9) The method of Item (8), wherein
the organic solvent is supplied to the vicinity of the ejecting portion of the extrusion head from before stopping the ejection of the coating liquid in step (c) to after starting the ejection of the coating liquid again in step (f)

(10) A method to produce a coated film comprising the sequential steps of:
(a) ejecting a coating liquid continuously from an ejecting portion of an extrusion head;
(b) applying the coating liquid ejected from the ejecting portion of the extrusion head onto a continuously conveyed film; and
(c) stopping the ejection of the coating liquid, wherein
an organic solvent is supplied to a vicinity of the ejecting portion of the extrusion head from before stopping the ejection of the coating liquid to after stopping the ejection of the coating liquid in step (c).

(11) The method of Item (10) further comprising the step of:
(d) moving the extrusion head away from the continuously conveyed film while the coating liquid is continuously ejected from the ejecting portion of the extrusion head.

(12) The method of Item (11), wherein
the organic solvent is supplied to the vicinity of the ejecting portion of the extrusion head from before step (d) to after step (d).

(13) A method to produce a coated film comprising the sequential steps of:
(a) ejecting a coating liquid continuously from an ejecting portion of an extrusion head;
(b) applying the coating liquid ejected from the ejecting portion of the extrusion head onto a continuously conveyed film;
(c) stopping the ejection of the coating liquid; and
(d) moving the extrusion head away from the continuously conveyed film while the coating liquid is continuously ejected from the ejecting portion of the extrusion head,
   wherein
an organic solvent is supplied to a vicinity of the ejecting portion of the extrusion head from before step (b) to after step (d).

(14) A coated film produced by the method of any one of (1) to (13).

Adhesion of a coating liquid on the ejecting portion of an extrusion head, which ejects a coating liquid, is prevented to provide a highly efficient manufacturing method of a coated film, and a stable manufacturing of a coated film having high quality has come to be possible.

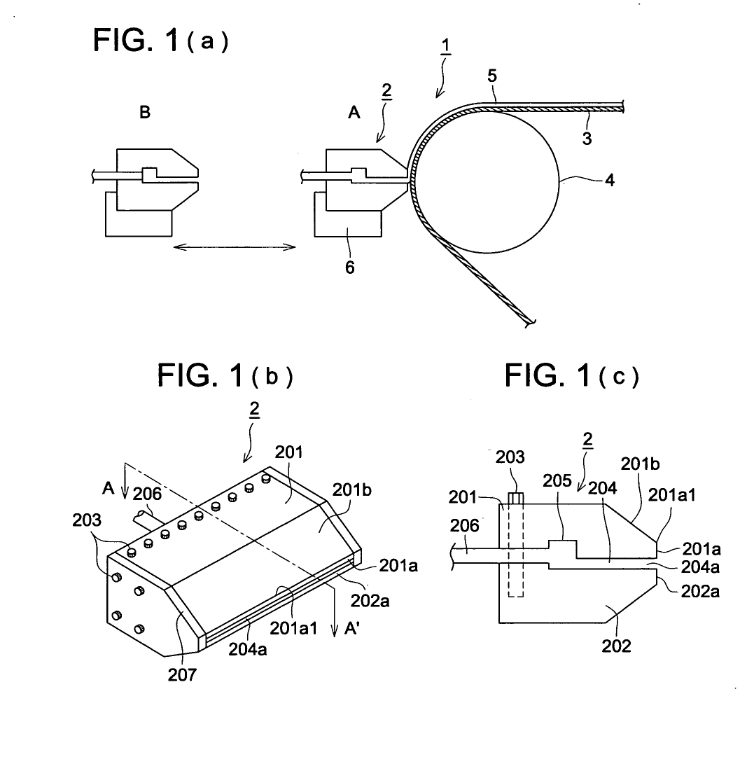

Embodiments of the present invention will be explained referring to FIGS. 1-4, however, the present invention is not limited thereto.

FIG. 1 is a schematic drawing to show a state of coating on the surface of a film to be coated by use of a conventional extrusion head. FIG. 1(a) is a schematic drawing to show a state of coating on the surface of a film to be coated by use of a conventional extrusion head. FIG. 1(b) is a schematic oblique view of an extrusion head of FIG. 1(a). FIG. 1(c) is a schematic cross sectional view along A-A′ of FIG. (b).

In FIG. 1, 1 is a coating apparatus. Coating apparatus 1 is provided with extrusion head 2 and backup roll 4 which support film to be coated 3. Film to be coated 3 is continuously transported from an unwinder (not shown in the drawing), being passed through backup roll 4 and a drying zone (not shown in the drawing), and wound by a take-up winder (not shown in the drawing). In a coating method shown in this drawing, extrusion head 2 is arranged at coating position A against a film to be coated at the time of passing backup roll 4 and eject a coating liquid from an ejecting portion to form coated layer 5. Extrusion head 2 can be shifted to waiting position B when coating is not performed, and the shifting is performed by shifting bed table 6 equipped with extrusion head 2 by a driving force of such as an air cylinder.

Extrusion head 2 is provided with two blocks 201 and 202 made of metal, and is assembled by being tightened with such as bolt 203. 204 is a slit formed by a gap between block 201 and block 202, and 204a is an ejecting portion of a coating liquid at the front portion. 205 is a portion to once store a coating liquid, which is called as a manifold, where a coating liquid is sent in from coating liquid supplying tube 206. A coating liquid having been stored along the coating width direction of manifold 205, is ejected through ejecting portion 204a of the front of slit 204 to be made into a uniform thickness along the coating width direction so that a coating liquid is coated on the surface of film to be coated 3. 201a is the front portion of block 201 and 202a is a front portion of block 202, and are totally called also as a lip portion. 201a1 is the upper front edge of lip portion 201a, and 201b is the surface connected to lip portion 201a of block 201. Lip portion 201a, upper edge 201a1 and surface 201b in the vicinity of 201a1 are listed as portions on which a coating liquid is easily adhered. The area expressed as “the vicinity of the ejecting portion of the extrusion head” contains the above mentioned lip portion 201a, upper edge 201a1 and surface 201b in the vicinity of 201a1. Lip portion 201a (202a) is a portion to face against backup roll 4, and a coating liquid is coated by forming a liquid stagnation, which is called as a bead, between this lip portion 201a (202a) and backup roll 4. Herein, side plates 207 may be arranged at the both edge portions in the coating width direction of extrusion head 2 for the purpose of liquid leakage prevention.

In the case of coating by use of an extrusion head of a pre-measurement method such as of conventional extrusion head 2 which is sown in this drawing, particularly when a utilized coating liquid is an organic solvent type, there are such problems described below. 1) At the time of waiting at waiting position B while ejecting a coating liquid (non-coating time), dried coating liquid may often be adhered on the lip portion, the upper edge of the lip portion and the vicinity thereof, resulting in generation of uneven coating (streak defects) when coating is performed after the extrusion head is shifted to the coating position. 2) A film to be coated generally takes a rolled form having a predetermined length and is spliced by use of such as a tape to perform continuous coating without stopping the running. Therefore, an extrusion head is shifted from coating position A toward waiting position B to let the spliced point pass through, and then shifted again to coating position A after the spliced point has passed. Meanwhile, sending of a coating liquid is seldom stopped because of it is a short time although it depends on a running speed of a film to be coated. Therefore, drying is often caused on the lip portion, the upper edge of the lip portion and the vicinity thereof to make adhesion of dried coating liquid on the lip portion, resulting in generation of uneven coating (streak defects) when coating is performed after shifting the extrusion head to the coating position.

The present invention relates to a coated film manufacturing method to manufacture a coated film by use of an extrusion head in which adhesion•coagulation of a coating liquid due to drying in the vicinity of ejecting portion 204a of the extrusion head at the non-coating time (during coating preparation at waiting position B, shifting to coating position A from waiting position B, and shifting to waiting position B from coating position A) is prevented. Herein, a coating position in the present invention refers to a position where coating on a film to be coated by use of an extrusion head is performed, and a waiting position refers to a position other than a coating position and a position to make an extrusion head wait at the non-coating time.

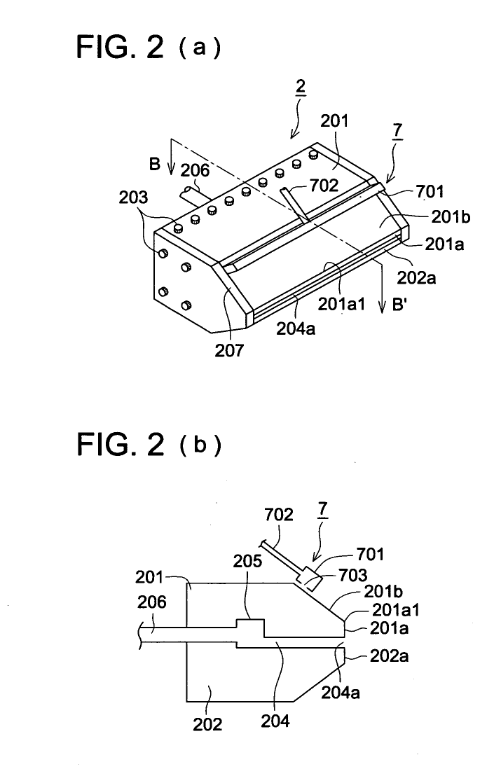

FIG. 2 is a schematic drawing of an extrusion head in which a solvent supply means is mounted on an extrusion head shown in FIG. 1. FIG. 2(a) is a schematic oblique view of an extrusion head in which a solvent supply means is mounted on an extrusion head shown in FIG. 1. FIG. 2(b) is a schematic cross-sectional view along B-B′ shown in FIG. 2(a).

In the drawing, 7 is a solvent supply means arranged on block 201 which constitutes extrusion head 2. Solvent supply means 7 is provided with main body 710 having a form of a cylinder, the both edge portions of which are closed, and solvent supply tube 702 which is mounted on main body 701. The width of main body 701 is preferably same as or wider than that of ejection portion 204a to uniformly supply a solvent supplied from solvent supply means 7 to the vicinity of the whole width of ejecting portion 204a of extrusion head 2. The form of a main body of solvent supply means 7 is not specifically limited and includes such as a circular type and a rectangular type. This drawing shows a rectangular type. Solvent supply means is held by a holding mechanism (not shown in the drawing), and is appropriately equipped with a shifting means (not shown in the drawing).

A solvent, which is supplied from solvent supply tube 702 to main body 701, is supplied from supply outlet 703 which is arranged on main body 701, being flown down on surface 201b of block 201 to be supplied to the vicinity of ejecting portion 204a, and prevent adhesion of a coating liquid by preventing drying in the vicinity of ejecting portion 204a. Herein, the vicinity of ejecting portion means the place where a coating liquid from the ejecting portion adheres and cannot be unequivocally determined depending on the form of a coating apparatus. In the present invention, the vicinity of ejecting portion 204a refers to the area where a coating liquid from ejecting portion 204a adheres, including, for example, lip portion 201a, upper edge 201a1 of lip portion 201a of block 201 which is connected to lip portion 201a and the surface in the vicinity of upper edge 201a1. A solvent is sent to solvent supply tube 702 through a solution sending path which is connected to solvent supply tube 702 by a piping of such as a hose by use of such as a metering pump. Other symbols are identical with those in FIG. 1.

A solvent supplied from a solvent supply means is preferably an organic solvent and is preferably a solvent same as a coating liquid which is supplied to an extrusion head. Further, such as methyl ethyl ketone, butyl acetate, hexanone, acetone and toluene can be also utilized by suitable selection corresponding to the type of a coating liquid.

The amount of a solvent supplied from a solvent supply means to the vicinity of ejecting portion 204a is an amount not to dry lip portion 201a and the surface of the vicinity of upper edge 201a1 of lip portion 201a of block 201 which is connected to lip portion 201a, and the optimum supply amount is determined by such as an experiment in advance. Solvent can be sent from solvent supply tube to main body 701 so as to maintain the optimum supply amount.

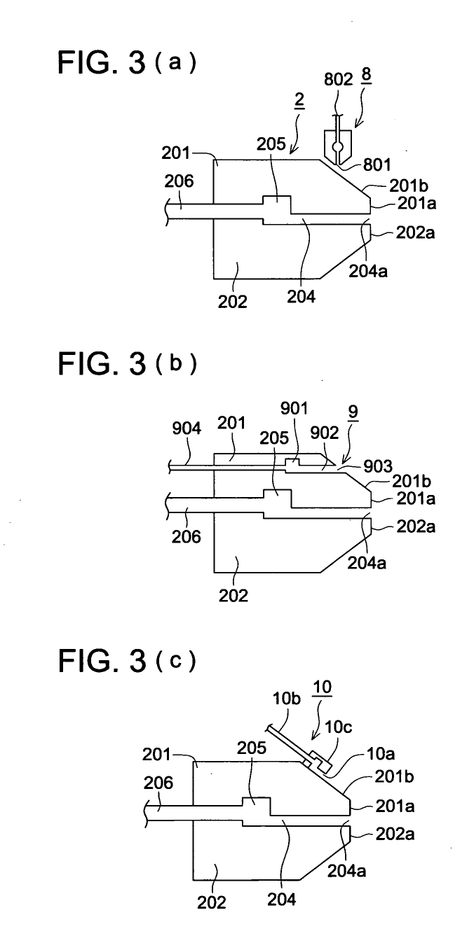

FIG. 3 is a schematic drawing of an extrusion head equipped with another solvent supply means. FIG. 3(a) will now be explained. 8 is a extrusion extrusion head type solvent supply means which is held by-a holding mechanism (not shown in the drawing) and is appropriately equipped with a shifting means (not shown in the drawing). 801 is a supply outlet of a solvent sent from solvent supply tube 802. The width of extrusion head type solvent supply means 8 is preferably same as or wider than that of ejection portion 204a to uniformly supply a solvent, which is supplied from solvent supply means 8, to the vicinity of the whole width of ejecting portion 204a of extrusion head 2.

FIG. 3(b) will now be explained. 9 is a solvent supply means arranged on block 201 of extrusion head 2, and is provided with small type manifold 901, slit 902 and solvent supply tube 904. A solvent, which is supplied from solvent supply tube, is supplied to the vicinity of ejecting portion 204a of extrusion extrusion head 2 through supply outlet 903. Supply outlet 903 preferably has a width same as or wider than that of ejecting portion 204a to uniformly supply a solvent over the whole width of ejecting portion 204a of extrusion head 2.

FIG. 3(c) will now be explained. 10 is a solvent supply means arranged on inclined plane 201b of block 201 of extrusion head 2. Solvent supply means 10 is constituted of part material 10c having solvent supply tube 10b which forms supply outlet 10a together with inclined plane 201b. Supply outlet 10a preferably has a width same as or wider than that of ejecting portion 204a to uniformly supply a solvent over the whole width of ejecting portion 204a of extrusion head 2. Other symbols are identical with those in FIG. 1.

Herein, the form and the arrangement position of solvent supply means shown in FIGS. 2 and 3 are not specifically limited provided being able to uniformly supply a solvent over the whole width vicinity of ejecting portion 204a of extrusion head 2, and, for example, the supply means may be a type to spray a solvent over the whole width vicinity of ejecting portion 204a.

A method to manufacture a coated film utilizing an extrusion head equipped with a solvent supply means, which is shown in FIG. 2 or 3, includes the following 4 ways.

1. A method in which a solvent is supplied to the vicinity of ejecting portion before starting ejection of a coating liquid from an ejecting outlet of an extrusion head, and thereafter a coating liquid is ejected through the aforesaid ejection outlet. This corresponds to a state in which an extrusion head is at a waiting position before to start coating. In this method, the following effects are obtained.

1) Since drying in the vicinity of an ejecting portion is prevented by supplying a solvent to the vicinity of an ejecting portion, adhesion•coagulation of a coating liquid in the vicinity of an ejecting portion is prevented, whereby generation of streak defects due to coagulum can be prevented.

2) The ejection amount of a coating liquid at a waiting position can be reduced to an amount not to cause precipitation in an extrusion head, and it is possible to restrain cost up of a coated film because of increased consumption efficiency of a coating liquid.

2. A method to start coating on a film to be coated by ejecting a coating liquid while a solvent is supplied to the vicinity of an ejecting portion of an extrusion head. This corresponds to a state at the time of shifting an extrusion extrusion head to a coating position from a waiting position and to start coating. In this method, the following effects are obtained.

1) Since a solvent is supplied to the vicinity of an ejecting portion at the starting time of coating, an apparent coating thickness is increased to make it easy to coat a coating liquid on a film to be coated, and coating support operations (such as (i) to insert a member between a film to be coated and an extrusion head to bridge a coating liquid with a film to be coated; and (ii) to bring the extrusion head closer to the film to be coated, then to return the extrusion head to the normal position after coating has started) are omitted to eliminate defects accompanied by the coating support operations, whereby improvement of operation efficiency has come to be possible.

2) Since a solvent is supplied to the vicinity of an ejecting portion at the start of coating, drying of the vicinity of an ejecting portion is prevented to prevent adhesion•coagulation of a coating liquid in the vicinity of an ejecting portion, whereby it becomes possible to prevent generation of streak defects due to coagulum. In particular, it is effective when avoidance of a connected point is often performed in the case of continuous coating for a long term, and adhesion•coagulation of a coating liquid in the vicinity of an ejecting portion is prevented even in continuous coating to enable stable manufacturing of a coated film.

3. A method to separate an extrusion head from a film to be coated and to perform coating while supplying a solvent to the vicinity of the aforesaid ejecting portion at the time of a coating liquid being coated from an ejecting portion of a coating liquid in the extrusion head. This corresponds the time such as to separate an extrusion head from a film to be coated, which is spliced with an adhesive tape, to avoid a connected point when a long length film to be coated is utilized. In this method, the following effects can be obtained.

1) Since the vicinity of an ejecting portion is always wet with a solvent, adhesion•coagulation of a coating liquid in the vicinity of an ejecting portion is prevented to enable prevention of generation of streak defects due to coagulum. In particular, it is effective when avoidance of a connected point is often performed in the case of continuous coating for a long term, and adhesion•coagulation of a coating liquid in the vicinity of an ejecting portion is prevented even in continuous coating to enable stable manufacturing of a coated film.

4. A method to supply a solvent in the vicinity of an ejecting portion before stopping ejection of a coating liquid from the ejecting portion of an extrusion head, and thereafter to stop ejection of a coating liquid from the ejecting portion followed by to stop supply of a solvent. In this method, the following effects can be obtained.

1) Since the vicinity of an ejecting portion is wet with a solvent, adhesion•coagulation of a coating liquid in the vicinity of an ejecting portion is prevented to make cleaning of an extrusion head after finish of coating easy, whereby improvement of working efficiency has come to be possible.

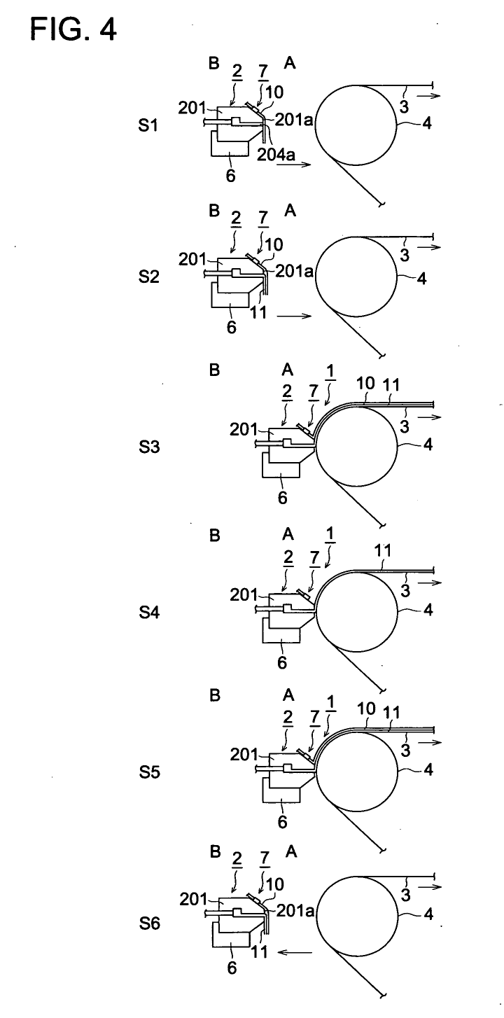

Methods shown in 1-4 are possible to be separately performed in a series of processes from coating preparation to finish of coating, or also naturally possible to be performed in combination. A specific concept in the case of combined practice of the method described in 1-4 is a manufacturing method, in which, when a coated film is manufactured by coating a coating liquid on the surface of a continuously running film to be coated by use of an extrusion head, which is provided with a solvent supply means to supply a solvent to the vicinity of an ejecting portion; at the time of start of coating, an extrusion head is shifted to the coating position from the waiting position while ejecting a coating liquid from an ejecting portion to coat a solvent and a coating liquid together on a film to be coated after supplying a solvent to the vicinity of an ejecting portion by a solvent supply means, and then supply of a solvent is stopped; at the time of separating an extrusion head from the coating position, a coating liquid is ejected from an ejecting portion while a solvent is supplied in the vicinity of an ejecting portion by a solvent supply means. A furthermore specific manufacturing method will be briefly explained referring to a schematic flow diagram of FIG. 4.

FIG. 4 is a schematic flow diagram of a manufacturing method of a coated film utilizing extrusion head 2 equipped with a solvent supply means shown in FIG. 2.

S1 is a state in which extrusion head 2 is at waiting position B. At the time to start coating, first, coating position A is determined corresponding to properties of a coating liquid to be coated. This means that the positions of extrusion head 2 and backup roll 4 have been determined in advance based on various experiments and calculations, and an extrusion head is adjusted so as to actually come to the position. After determining the coating position A, extrusion head 2 is shifted by shifting support table 6 to waiting position B by an operation force of such as an air cylinder. Thereafter, solvent 10 is flown out through supply outlet 703 (refer to FIG. 2) to be supplied to the vicinity of ejecting portion 204a of extrusion head 2. The solvent supplied is recovered by a receiving vessel (not shown in the drawing) arranged under extrusion head 2.

S2 shows a state in which extrusion head is at waiting position B while a solvent is flowing out from solvent supply means 7. Next solution 11 is ejected from ejecting portion of extrusion extrusion head 2 in a state of a solvent being flowing out from solvent supply means 7. Coating liquid 11 ejected is recovered together with solvent 10 by a receiving vessel arranged under extrusion head 2 (not shown in the drawing). By ejecting coating liquid 11 from ejecting portion 204a of extrusion head 2 in a state of a solvent being flowing out from solvent supply means 7, it is possible to prevent adhesion of coating liquid 11 on lip portion 201a and the surface of the vicinity of upper edge 201a1 (refer to FIG. 2) of lip portion 201a on plane 201b (refer to FIG. 2) of block 201 which is connected to lip portion 201a.

S3 indicates a state in which extrusion head 2 is shifted to coating position A and coating is performed. In this stage, solvent 10 and coating liquid 11 together are in a state of being continuously coated on the surface of a film to be coated which is continuously running. Since solvent 10 is supplied also during coating is performed at coating position A as well as during waiting at waiting position B, it is possible to prevent adhesion of coating liquid 11 on lip portion 201a and the surface of the vicinity of upper edge 201a1 (refer to FIG. 2) of lip portion 201a on plane 201b (refer to FIG. 2) of block 201 which is connected to lip portion 201a.

S4 indicates a state in which supply of solvent 10 is stopped from the state indicated in S3 and coating is performed on a continuously running film to be coated.

S5 indicates a state of before extrusion head 2 being shifted to waiting position B from coating position A. In this stage, a solvent is supplied from solvent supply means 7 to the vicinity of a coating liquid ejecting portion and a solvent and a coating liquid together are coated.

S6 indicates a state of extrusion head 2 having been shifted to waiting position B from coating position A. When continuous coating is performed on a continuously running film to be coated, an example to shift extrusion head to waiting position B is an avoidance of coating on a spliced point of a film to be coated. Generally, since a film to be coated, which is utilized in a continuous coating, is made into a long length by splicing a film to be coated having a predetermined length with such as a tape and spliced portion becomes thicker, it is often highly dangerous that the spliced portion may be pinched between extrusion head 2 and backup roll 4 resulting in break of the film or disturbance of coating to generate coating defects; therefore extrusion head 2 is moved to waiting position B to avoid the spliced portion. At the time of moving extrusion head 2 to waiting position B, by supplying a solvent from solvent supply means 7 while ejecting a coating liquid from an ejecting portion, it is possible to prevent adhesion of coating liquid 11 on lip portion 201a and the surface of the vicinity of upper edge 201a1 (refer to FIG. 2) of lip portion 201a of plane 201b (refer to FIG. 2) of block 201 which is connected to lip portion 201a. The state of the extrusion head which is moved to waiting position B is identical with the state indicated in S2. After spliced portion has passed, the coating is restarted by repeating from S3 to S6, and S6-S3-S6 are repeated to pass the spliced portion of a film to be coated. Herein, at the time to stop coating liquid ejection, it is preferable to stop supply of a solvent after stopping ejection of a coating liquid in a state of the extrusion head being at waiting position indicated in S6.

By utilizing an extrusion head equipped with a solvent supply means shown in FIGS. 2 and 3, and a coated film is manufactured by employing a manufacturing method shown in FIG. 4, the following effects can be obtained. 1) By preventing drying at the lip portion, at the upper edge of the lip portion and in the vicinity thereof at the time of waiting at a waiting position while ejecting a coating liquid (non-coating time), it becomes possible to prevent adhesion•coagulation of a coating liquid at the lip portion, at the upper edge of the lip portion and in the vicinity thereof, whereby manufacturing of a coated film having high quality without generation of uneven coating (streak defects) has come to be possible. 2) In the case of shifting an extrusion head to the waiting position and restarting coating (such as at the time to avoid a spliced portion of a film to be coated, and at the time to interrupt coating) during continuous coating, it has come to be possible to immediately restart coating resulting in significant reduction of the loss. 3) Coating of a coating liquid on a film to be coated at the start of coating becomes easy, and complicated coating support operations at the start of coating are eliminated, resulting in improved working efficiency and prevention of defects accompanied with coating support operations to enable manufacturing of a coated film of high quality. 4) Uneven coating (streak defects) can be significantly decreased resulting in improvement of the yield. 5) Cleaning operations of a lip portion, the upper edge of the lip portion and the vicinity of thereof are eliminated to enable improvement of working efficiency. 6) Since ejection of a coating liquid can be decreased to an amount not to cause precipitation of a coating liquid in an extrusion head at the time of waiting at the waiting position while ejecting a coating liquid (non-coating time), consumption efficiency is raised to enable depression of cost of a coated film.

Functional materials which can be manufactured by a manufacturing method of a coated film according to the present invention are not specifically limited and include, for example, silver halide photosensitive materials for general use and industrial use, thermosensitive materials, heat developable photosensitive materials, photoresist, optical films utilized for a device of an electro-optical panel such as an LCD and an organic EL. Among these, it is preferable to be utilized for manufacturing of an optical film having a functional layer applied for a device of an electro-optical panel such as a LCD or an organic EL element which specifically requires high performance.

A material utilized for a film to be coated according to the present invention is not specifically limited and includes, for example, cellulose ester films, polyester films, polycarbonate films, polyallylate films, polysulfone (including polyether sulfone) films, polyester films such as polyethylene terephthalate and polyethylene naphthalate, polyethylene film, polypropylene film, cellophane, cellulose diacetate film, cellulose triacetate film, cellulose acetate butyrate film, polyvinylidene chloride film, polyvinylalcohol film, ethylene vinylalcohol film, syndiotactic polystyrene film, polycarbonate film, cycloolefin polymer film (Arton (manufactured by JSR Corp.), Zenex and Zeonea (manufactured by Nippon Zeon Corp.), polymethylpentene film, polyether ketone film, polyether ketone imide film, polyamide film, fluorine resin film, nylon film, polymethylmethacrylate film and acryl film. These films may be either those manufactured by a fusion extrusion method or those manufactured by a solution casting method. The method can be appropriately selected depending on-product to be manufactured. As an optical film among these materials, cellulose ester is specifically suitably utilized since being excellent in transparency, heat resistance and matching with liquid crystal and having a small intrinsic double refractive index and a small optical modulus of elasticity.

The cellulose ester of the present invention is a single acid or mixed acid ester containing at least one of the structures of an aliphatic acyl groupa and a substituted or unsubstituted aromatic acyl group. In the case when an aromatic acyl group is contained and the aromatic ring is a benzene ring, examples of a substituent include: a halogen atom, a cyano group, an alkyl group, a cycloalkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R)(—O—R), —P(—O—R)₂, —PH(═O)—R—P(═O)(—R)₂, —PH(═O)—O—R, —P(═O)(—R)(—O—R), —P(═O)(—O—R)₂, —O—PH(═O)—R, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of the present invention, in the case where the hydrogen atom of the hydroxyl group portion of the-cellulose is a fatty acid ester with a aliphatic acyl group, the number of carbon atoms in the aliphatic acyl group is 2-20, and specific examples thereof include acetyl, propionyl, butyryl, isobutyryl, valeryl, pivaroyl, hexanoyl, octanoyl, lauroyl and stearoyl.

The aliphatic acyl group of the present invention also refers to one which is further substituted, and examples of the benzene ring substituent group include those given as examples when the aromatic ring in the aromatic acyl group is a benzene ring.

When the esterified substituent group of cellulose ester is an aromatic ring, the number of the substituent groups X which are substituted on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycylic compound (such as naphthalene, indene, indan, phenanthrene, quinoline, isoquinilene, chromene, chromane, phthalazine, acridine, indole and indolin).

The structure used in the cellulose ester of the present invention has a structure selected from at least one of a substituted or unsubstituted aliphatic acyl group or a substituted or unsubstituted aromatic acyl group, and these may be a single acid or a mixed acid ester, and two or more types of cellulose esters may be mixed and used.

The cellulose ester used in the present invention is preferably at least one type selected from cellulose acetate, cellulose propionate, cellulose butyrate, cellulose acetate propionate, cellulose acetate butyrate, cellulose acetate phthalate and cellulose phthalate.

In terms of the degree of substitution for the mixed fatty acid ester, the short chain fatty acid ester of the cellulose acetate propionate, and cellulose acetate butyrate which are most preferable, have an acyl group having 2-4 carbon atoms as the substituent group, and given that the substituent group for the acetyl group is represented by X and the substituent group for the propionyl group or the butyryl group is represented by Y, the cellulose resin includes cellulose esters which simultaneously satisfy both Equation (I) and Equation (II) below.

2.6≦X+Y≦3.0 Equation (I)

0≦X≦2.5 Equation (II)

Cellulose acetate propionate is preferably used herein, and of the cellulose acetate propionates, those that satisfy 1.9≦X≦2.5 and 0.1≦Y≦0.9 are particularly preferable. The portion of the acyl group that is not substituted is usually a hydroxyl group. These may be synthesized by a known method.

In the cellulose ester used in the present invention, the ratio of the weight average molecular weight Mw/number average molecular weight Mn is preferably 1.5-5.5, while 2.0-5.0 is particularly preferable, 2.5-5.0 is more preferable and 3.0-5.0 is even more preferable.

The cellulose which is the raw material for the cellulose ester of the present invention may be wood pulp or cotton linter, and the wood pulp may be that of a needle-leaf tree or a broad-leaf tree, but that of the needle-leaf tree is more preferable. Cotton linter is preferably used in view of peeling properties at the time of film formation. Cellulose esters made from these substances may be suitably blended or used alone.

For example, the proportion used of cellulose ester from cotton linter:cellulose ester from wood pulp (needle-leaf tree):cellulose ester from wood pulp (broad-leaf tree) may be 100:0:0, 90:10:0, 85:15:0, 50:50:0, 20:80:0, 10:90:0, 0:100:0, 0:0:100; 80:10:10, 85:0:15, and 40:30:30.

The coating liquid of the present invention preferably contains 0.5-20 weight % of a polymer. Examples of the polymer include: gelatin, methyl cellulose, carboxymethyl cellulose, polyacrylic acid, polyvinyl ether, polyvinyl alcohol, polyvinyl pyrrolidone and a natural rubber.

The coating liquid containing foregoing polymer is not specifically limited. Examples of such a coating liquid include coating liquids for: a silver halide photosensitive material for general use or industrial use; a heat-sensitive material; a photothermographic material; a photoresist; and a device for an electro-optical panel represented by LCD or an organic electroluminescent element.

The device for an electro-optical panel includes an optical film having an antireflection layer, which is provided on the front surface of a CRT or a liquid crystal display in order to improve the visibility. By the way, the surface of a large screen display such as that of a television easily gets scratched in touch with a film. Accordingly, an optical film prepared by forming a clear hard coat layer or an antireflection layer on a support is usually provided on the surface in order to prevent scratching. Optical films prepared by forming a clear hard coat layer or an antireflection layer on a support will be described below.

An optical film having a clear hard coat layer will now be explained. An actinic ray curable resin layer is preferably employed as the clear hard coat layer. The actinic ray curable resin layer refers to a layer which contains, as a main component, a resin cured through a crosslinking reaction when exposed to actinic rays such as UV light or electron beams. The actinic ray curable resin layer preferably contains an ethylenically unsaturated monomer, which is exposed to actinic rays such as UV light or electron beams and cured to form a hard coat layer. Listed as representative actinic ray curable resins are UV curable resins as well as electron beam curable resins. The actinic ray curable resin is preferably a UV curable resin.

Listed as UV curable resins may be, for example, UV curable urethane acrylate resins, UV curable polyester acrylate resins, UV curable epoxy acrylate resins, UV curable polyol acrylate resins, or UV curable epoxy resins.

The UV curable urethane acrylate resins are easily prepared in such a manner that an acrylate monomer having a hydroxyl group such as 2-hydroxyethyl acrylate, 2-hydroxyethyl methacrylate (hereinafter, acrylate includes acrylate itself and methacrylate, and acrylate represents both), or 2-hydroxypropyl acrylate are allowed to react with the product which is commonly prepared by allowing a polyester polyol to react with an isocyanate monomer or prepolymer. For example, those described in JP-A No. 59-151110 can be used. For example, preferably employed is a mixture comprising 100 parts of Unidick 17-806 (manufactured by Dainippon Ink and Chemicals Inc.) and one part of Coronate L (manufactured by Nippon Urethane Industry Co., Ltd.).

The UV ray curable polyesteracrylate resins include those prepared easily by reacting a polyesterpolyol with 2-hydroxyethylacrylate or 2-hydroxypropylacrylate, disclosed for example, in JP-A No. 59-151112.

Examples of the UV ray curable epoxyacrylate resin include those prepared by reacting an epoxyacrylate oligomer in the presence of a reactive diluting agent and a photoinitiator, disclosed for example, in JP-A No. 1-105738.

Examples of the UV ray curable polyol acrylate resin include trimethylolpropane triacrylate, ditrimethylolpropane tetraacrylate, pentaerythritol triacrylate, pentaerythritol tetraacrylate, dipentaerythritol hexaacrylate or alkyl-modified dipentaerythritol pentaacrylate.

The photoinitiators for the UV ray curable resins include benzoine or its derivative, or acetophenones, benzophenones, hydroxy benzophenones, Michler's ketone, α-amyloxime esters, thioxanthones or their derivatives. an oxime ketone derivative, a benzophenone derivative or a thioxanthone derivative. These photoinitiators may be used together with a photo-sensitizer. The above photoinitiators also work as a photo-sensitizer. Sensitizers such as n-butylamine, triethylamine and tri-n-butylphosphine can be used in photo-reaction of epoxyacrylates. The content of the photoinitiators or sensitizers in the UV ray curable resin layer is 0.1 to 15 parts by weight, and preferably 1 to 10 parts by weight, based on the 100 parts by weight of the UV ray curable resin layer.

The polymerizable monomers having one unsaturated double bond in the molecule include methyl acrylate, ethyl acrylate, butyl acrylate, benzyl acrylate, cyclohexyl acrylate, vinyl acetate, and styrene. The polymerizable monomers having two or more unsaturated double bonds in the molecule include ethylene glycol diacrylate, propylene glycol diacrylate, divinylbenzene, 1,4-cyclohexane diacrylate, 1,4-cyclohexyldimethyl diacrylate, trimethylol propane triacrylate, and pentaerythritol tetraacrylate.

The UV curable resins available on the market utilized in the present invention include Adekaoptomer KR, BY Series such as KR-400, KR-410, KR-550, KR-566, KR-567 and BY-320B (manufactured by Asahi Denka Co., Ltd.); Koeihard A-101-KK, A-101-WS, C-302, C-401-N, C-501, M-101, M-102, T-102, D-102, NS-101, FT-102Q8, MAG-1-P20, AG-106 and M-101-C (manufactured by Koei Kagaku Co., Ltd.); Seikabeam PHC2210(S), PHC X-9(K-3), PHC2213, DP-10, DP-20, DP=30, P1000, P1100, P1200, P1300, P1400, P1500, P1600, SCR900 (manufactured by Dainichiseika Kogyo Co., Ltd.); KRM7033, KRM7039, KRM7131, UVECRYL29201 and UVECRYL29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by Dainippon Ink & Chemicals, Inc.); Olex No.340 Clear (manufactured by Chyugoku Toryo Co., Ltd.); Sunrad H-601, RC-750, RC-700, RC-600, RC-500, RC-611 and RC-612 (manufactured by Sanyo Kaseikogyo Co., Ltd.); SP-1509 and SP-1507 (manufactured by Syowa Kobunshi Co., Ltd.); RCC-15C (manufactured by Grace Japan Co., Ltd.) and Aronix M-6100, M-8030 and M-8060 (manufactured by Toagosei Co., Ltd.).

Concrete examples include trimethylol propane triacrylate, ditrimethylol propane tetracrylate, pentaerythritol triacrylate, pentaerythritol tetracrylate, dipentaerythritol hexaacrylate and alkyl modified dipentaerythritol pentaacrylate.

These actinic ray curable resin layers can be applied by any method well known in the art, for example: a gravure coater, a dip coater, a reverse coater, a wire bar coater, a die coater and ink jet printing.

Light sources to cure layers of UV curable-resin by photo-curing reaction are not specifically limited, and any light source may be used as far as UV ray is generated. For example, a low-pressure mercury lamp, a medium-pressure mercury lamp, a high-pressure mercury lamp, an ultrahigh-pressure mercury lamp, a carbon arc lamp, a metal halide lamp and a xenon lamp may be utilized. The preferable irradiation quantity of light may be changed depending on the type of lamp, however, it is preferably from 5 to 150 mJ/cm², and more preferably from 20 to 100 mJ/cm². Irradiation of an actinic ray is preferably carried out under tension in the longitudinal direction of the film and more preferably under tension in both the lateral and the longitudinal directions. The preferable tension is from 30 to 300 N/m.

An organic solvent used for a coating liquid of the UV curable-resin can be selected from, for example, hydrocarbons (toluene and xylene), alcohols (methanol, ethanol, isopropanol, butanol and cyclohexanol), ketones (acetone, methylethyl ketone and methylisobutyl ketone), esters (methyl acetate, ethyl acetate and methyl lactate), glycol ethers and other organic solvents. These organic solvents may be also used in combination. The above mentioned organic solvents preferably contain propylene glycol monoalkyl ether (the alkyl having 1 to 4 carbon atoms) or propylene glycol monoalkyl ether acetate (the alkyl having 1 to 4 carbon atoms) in an amount of 5% by weight or more, and more preferably from 5 to 80% by weight.

In a coating liquid of a UV ray-curable resin, a silicon compound such as a polyether modified silicone oil, is preferably added. The number average molecular weight of the polyether modified silicone oil is preferably from 1,000 to 100,000 and more preferably from 2,000 to 50,000. Addition of the polyether modified silicone oil with a number average molecular weight of less than 1,000 may lower the drying rate of the coating liquid, while that of more than 100,000 may be difficult to bleed out at the surface of the coated film.

Silicone compounds available on the market include, for example: DKQ8-779 (a trade name of Dow Corning Corp.), SF3771, SF8410, SF8411, SF8419, SF8421, SF8428, SH200, SH510, SH1107, SH3771, BX16-034, SH3746, SH3749, SH8400, SH3771M, SH3772M, SH3773M, SH3775M, BY-16-837, BY-16-839, BY-16-869, BY-16-870, BY-16-004, BY-16-891, BY-16-872, BY-16-874, BY22-008M, BY22-012M, FS-1265 (all being trade names of Dow Corning Toray Silicone Co., Ltd.), KF-101, KF-100T, KF351, KF352, KF353, KF354, KF355, KF615, KF618, KF954, KF6004, siliconeX-22-945, X22-160AS (all being trade names of Shin-Etsu Chemical Co., Ltd.), XF3940, XF3949 (both being trade names of Toshiba Silicones Co., Ltd.), DISPARLONLS-009 (a trade name of Kusumoto Chemicals Ltd.), GLANOL410 (a trade name of Kyoeisha Chemicals Co., Ltd.), TSF4440, TSF4441, TSF4445, TSF4446, TSF4452, TSF4460 (all being trade names of GE Toshiba Silicones Co., Ltd.), BYK-306, BYK-330, BYK-307, BYK-341, BYK-361 (all being trade names of BYK-Chemie Japan KK), L Series (L-7001, L-7006, L-7604 and L-9000), Y Series and FZ Series (FZ-2203, FZ-2206 and FZ-2207) (all from Nippon Unicar Co., Ltd.).

These compositions may improve the coating ability of a coating liquid onto a substrate or an under coat layer. These compounds used in the top layer of film may contribute to improve scratch resistance of the film as well as water-resistance, oil-resistance and anti-stain properties of the film. The content of the silicon compound is preferably from 0.01 to 3% by weight based on the solid components in the coating liquid.

The aforementioned coating methods are also used as coating method of a UV ray-curable resin layer coating liquid. The wet thickness of the coated UV-curable resin layer is preferably from 0.1 to 30 μm and more preferably from 0.5 to 15 μm. The dry thickness of the coated UV-curable resin layer is preferably from 0.1 to 20 μm, more preferably from 1 to 10 μm and specifically preferably from 8 to 20 μm.

The pencil hardness of the hard coat layer is preferably 2 H-8 H and more preferably 3 H-6 H. The pencil hardness is determined as follows using a film sample which is subjected to a humidity condidtioning under a condition of 25° C. and a relative humidity of 60% for 2 hours. According to the method defined by JIS-K-5400, the film sample is scraped 10 times at a loading weight of 1 kg with a pencil of which hardness is defined by JIS-S-6006, and the hardness of the pencil which cause no scratch on the film samples is determined to be the pencil hardness of the film sample.

The UV ray-curable resin layer is preferably irradiated with UV rays during or after drying. The duration of UV ray irradiation is preferably from 0.1 seconds to 5 minutes in order to secure the exposure amount from 5 to 150 mJ/cm² as mentioned above. In view of working efficiency and hardening efficiency of the UV-curable resin layer, the duration is more preferably from 0.1 to 10 seconds. Intensity of the actinic ray is preferably from 50 to 150 mW/cm² on the irradiated surface.

An optical film having an antireflection layer will now be explained. The antireflection layer employed in the optical film of the present invention may be a single layer containing only a low refractive index layer or may contain a plurality of layers having different refractive indexes. In general, the antireflection layer is laminated on a hard coat layer (a clear hard coat layer or an anti-glare layer) applied on the optical film to be coated so as to reduce the reflectance by considering the refractive index and the thickness of each layer, the number and the order of laminated layers. The antireflection layer may be formed in combination of a high refractive index layer having a refractive index higher than that of the optical film and a low refractive index layer having a refractive index lower than that of the optical film, or, specifically preferably, the antireflection layer may be formed with three or more layers having different refractive indexes in which three layers having different refractive indexes are laminated in the order from the side closer to the optical film to be coated: an intermediate refractive index layer (having a refractive index higher than that of the optical film to be coated or the hard coat layer while lower than that of the high refractive index layer)/a high refractive index layer/a low refractive index layer. The hard coat layer may have a function of a high refractive index layer.

Examples of the preferable layer constitution of the antireflection layer will be shown below, wherein the symbol “/” represents that the layers are laminated.

Optical film to be coated/hard coat layer/low refractive index layer

Optical film to be coated/hard coat layer/high refractive index layer/low refractive index layer

Optical film to be coated/hard coat layer/intermediate refractive index layer/high refractive index layer/low refractive index layer

Optical film to be coated/antistatic layer/hard coat layer/intermediate refractive index layer/high refractive index layer/low refractive index layer

Optical film to be coated/hard coat layer/inside refractive index layer/high refractive index layer/low refractive index layer

Optical film to be coated/hard coat layer/high refractive index layer/low refractive index layer/high refractive index layer/low refractive index layer

### <Low-Refractive Index Layer>

The following hollow silica particles are preferably employed for a low refractive index layer of the present invention.

### (Hollow Silica Particles)

Hollow particles are (I) complex particles constituted of a porous particle and a cover layer arranged on the surface of said porous particle or (II) hollow particles, the interior of which is hollow and the hollow is filled with contents such as a solvent, a gas or a porous substance. Herein, at least either (I) complex particles or (II) hollow particles is contained in a low refractive index layer, or the both of them may be contained.

Herein, hollow particles are particles the interior of which is hollow, and the hollow is surrounded by a particle wall. The interior of the hollow is filled with the contents such as a solvent, a gas or a porous substance which have been utilized in preparation. The mean particle diameter of such hollow particles is preferably in a range of 5-300 nm and preferably of 10-200 nm. The mean particle diameter of hollow particles utilized is appropriately selected depending on the thickness of the formed transparent cover film and is preferably in a range of ⅔- 1/10 of the layer thickness of the transparent cover film of such as a formed low refractive index layer. These hollow particles are preferably utilized in a state of being dispersed in a suitable medium to form a low refractive index layer. As dispersing medium, water, alcohol (such as methanol, ethanol and isopropanol), ketone (such as methyl ethyl ketone and methyl isobutyl ketone) and ketone alcohol (such as diacetone alcohol) are preferable.

A thickness of the cover layer of a complex particle or the thickness of the particle wall of a hollow particle is preferably in a range of 1-20 nm and more preferably in a range of 2-15 nm. In the case of a complex particle, when a thickness of the cover layer is less than 1 nm, a particle may not be completely covered to allow such as silicate monomer or oligomer having a low polymerization degree as a coating component described later to immerse into the interior of the complex particle resulting in decrease of porousness of the interior, whereby an effect of a low refractive index may not be obtained. Further, when a thickness of the cover layer is over 20 nm, the aforesaid silicate monomer or oligomer never immerses into the interior, however, the porosity (a micro-pour volume) of a complex particle may be decreased, resulting in an insufficient effect of a low refractive index. Further, in the case of a hollow particle, particle shape may not be kept when a thickness of the particle wall is less than 1 nm, while an effect of a low refractive index may not be obtained when a thickness of the particle wall is not less than 20 nm.

The cover layer of a complex particle or the particle wall of a hollow particle is preferably comprised of silica as a primary component. Further, components other than silica may be incorporated and specific examples include such as Al₂O₃, B₂O₃, TiO₂, ZrO₂, SnO₂, CeO₂, P₂O₃, Sb₂O₃, MoO₃, ZnO₂, and WO₃. A porous particle to constitute a complex particle includes those comprised of silica, those comprised of silica and an inorganic compound other than silica and-those comprised of such as CaF₂, NaF, NaAlF₆ and MgF. Among them, specifically preferable is a porous particle comprised of a complex oxide of silica and an inorganic compound other than silica. An inorganic compound other than silica includes one type or at least two types of such as Al₂O₃, B₂O₃, TiO₂, ZrO₂, SnO₂, CeO₂, P₂O₃, Sb₂O₃, MoO₃, ZnO₂ and WO₃. In such a porous particle, mole ratio MOₓ/SiO₂ is preferably in a range of 0.0001-1.0 and more preferably of 0.001-0.3 when silica is represented by SiO₂ and an inorganic compound other than silica is represented by an equivalent oxide (MOₓ). A porous particle having mole ratio MOₓ/SiO₂ of less than 0.0001 is difficult to be prepared and the pore volume is small to unable preparation of a particle having a low refractive index. Further, when mole ratio MOₓ/SiO₂ of a porous particle is over 1.0, the pore volume becomes large due to a small ratio of silica and it may be further difficult to prepare a particle having a low refractive index.

A pore volume of such a porous particle is preferably in a range of 0.1-1.5 ml/g and more preferably of 0.2-1.5 ml/g. When the pore volume is less than 0.1 ml/g, a particle having a sufficiently decreased refractive index cannot be prepared, while, when it is over 1.5 ml/g, strength of a particle is decreased and strength of the obtained cover film may be decreased. Herein, the pore volume of such a porous particle can be determined by a mercury pressurized impregnation method. Further, a content of a hollow particle includes such as a solvent, a gas and a porous substance which have been utilized at preparation of the particle. In a solvent, such as a non-reacted substance of a particle precursor which is utilized at hollow particle preparation and a utilized catalyst may be contained. Further, a porous substance includes those comprising compounds exemplified in the aforesaid porous particle. These contents may be those containing single component or mixture of plural components.

As a manufacturing method of such hollow particles, a preparation method of complex oxide colloidal particles, disclosed in paragraph Nos. [0010]-[0033] of Japanese Patent O.P.I. Publication No. 7-133105, is suitably applied.

The refractive index of the resulting hollow particle is low because of the hollow structure, and the refractive index of the resulting hollow particle in the present invention is preferably 1.30-1.50, and more preferably 1.35-1.44.

The content (by weight) of hollow silica particles having an outer layer as well as pores or cavities in a low refractive index layer coating liquid is 10-80% by weight, and more preferably 20-60% by weight.

### (Tetraalcoxy Silane Compound or Hydrolysate Thereof)

A tetraalcoxy silane compound or its hydrolysate as a sol-gel material is preferably contained in a low refractive index layer of the present invention.

As components for the low refractive index layer usable in the present invention, organic group-containing silicon oxides other than the foregoing inorganic silicon oxides are preferably usable. These are generally called sol-gel components. Preferably employed as such sol-gel components may be metal alcolates, and organoalkoxy metal compounds and hydrolysis products thereof. Particularly preferred are alkoxysilane, and hydrolysis products thereof. It is also preferable to use tetraalkoxysilane (tetramethoxysilane and tetraethoxysilane), alkyltrialkoxysilane (methyltrimethoxysilane, and ethyltrimethoxysilane), aryltrialkoxysilane (phenyltrimethoxysilane), dialkyldialkoxysilane, diaryldialkoxysilane, and the like.

It is preferred that the low refractive index layer employed in the present invention contains the foregoing silicon oxide and the following silane coupling agent. Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethbxyethoxysilane, phenyltrimethoxysilane, phenyltriethoxysilane, and phenyltriacetoxysilane. Further, examples of silane coupling agents having two alkyl substituents for silicon include dimethyldimethoxysilane, phenylmethyldimethoxysilane, dimethyldiethoxysilane, and phenylmethyldiethoxysilane.

Specific examples of silane coupling agents produced by Shin-Etsu Chemical Co., Ltd include KBM-303, KBM-403, KBM-402, KBM-403, KBM-1403, KBM-502, KBM-503, KBE-502, KBE-503, KBM-603, KBE-603, KBM-903, KBE-903, KBE-9103, KBM-802 or KBM-803.

It is preferred that the silane coupling agent is hydrolyzed with a predetermined amount of water in advance. When a silane coupling agent is hydrolyzed, the surface of the foregoing silicon oxide particle or the silicon oxide particle containing an organic group is easy to be reactive, resulting in formation of strengthened films. The silane coupling agent which has been hydrolyzed may also be added into a coating liquid in advance.

It is also preferable that the low refractive index layer incorporates polymers in an amount of 5-50 percent by weight. The above polymers exhibit functions such that particles are subjected to adhesion and the structure of the above low refractive index layer is maintained. The used amount of the polymers is controlled so that without filing voids, it is possible to maintain the strength of the low refractive index layer. The amount of the polymers is preferably 10-30 percent by weight of the total weight of the low refractive index layer. In order to achieve adhesion of particles employing polymers, it is preferable that (1) polymers are combined with surface processing agents of particles, (2) a polymer shell is formed around a particle used as a core, or (3) polymers are employed as a binder among particles.

Binder polymers are preferably polymers having saturated hydrocarbon or polyether as a main chain, but is more preferably polymers having saturated hydrocarbon as a main chain. The above binder polymers are subjected to crosslinking. It is preferable that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups. Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol tetra(meth)acrylate, pentaerythritol(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides.

The low refractive index layers may be a low refractive index layer formed by crosslinking of fluorine containing resins (hereinafter referred to as “fluorine containing resins prior to crosslinking”) which undergo crosslinking via heating or ionizing radiation. Preferably listed as fluorine containing resins prior to coating are fluorine containing copolymers which are formed employing a fluorine containing vinyl monomer and a monomer which provides a crosslinking group. Listed as specific examples of the above fluorine containing vinyl monomer units include: fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol(meth)acrylate, hydroxyalkyl(meth)acrylate, allyl acrylate, hydroxyalkyl vinyl ether, and hydroxyalkyl allyl ether). Japanese Patent O.P.I. Publication Nos. 10-25388 and 10-147739 describe that a crosslinking structure is introduced into the latter by *adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

The ratio of each monomer to form the fluorine containing copolymers prior to coating is as follows. The ratio of fluorine containing vinyl monomers is preferably 20-70 mol percent, but is more preferably 40-70 mol percent; the ratio of monomers to provide a crosslinking group is preferably 1-20 mol percent, but is more preferably 5-20 mol percent, and the ratio of the other monomers simultaneously employed is preferably 10-70 mol percent, but is more preferably 10-50 mol percent.

The low refractive index layer can be formed via coating, employing a dip coat method, an air knife coat method, a curtain coat method, a roller coat method, a wire bar coat method, a gravure coat method, or an extrusion coat method (U.S. Pat. No. 2,681,294). Two or more layers may be applied simultaneously. The method of simultaneous application is described in, for example, U.S. Pat. Nos. 2,761,791, 2,941,898, 3,508,947, 3,526,528 and “Yuji Harasaki: Coating Engineering, p. 253 (1973), published by Asakura Publishing Co., Ltd.” The low refractive index layer of the present invention preferably has a thickness of 50-200 nm, and more preferably has a thickness of 60-150 nm.

### (High Refractive Index Layer and Medium Refractive Index Layer)

A high refractive index layer is preferably arranged between a transparent support and a low refractive index layer. Further, to arrange a medium refractive index layer between a transparent substrate and a high refractive index layer is preferred to reduce the reflectance. A refractive index of a high refractive index layer is preferably 1.55-2.30 and more preferably 1.57-2.20. A refractive index of a medium refractive index layer is adjusted to be an intermediate value between a refractive index of a transparent support and a refractive index of a high refractive index layer. A refractive index of a medium refractive index layer is preferably 1.55-1.80. Thickness of a high refractive index layer and a medium refractive index layer is preferably 5 nm-1 μm, more preferably 10 nm-0.2 μm and most preferably 30 nm-0.1 μm. The haze of a high refractive index layer and a medium refractive index layer is preferably not more than 5%, more preferably not more than 3% and most preferably not more than 1%. The strength of a high refractive index layer and a medium refractive index layer is preferably not less than H based on pencil hardness at a loading weight of 1 kg, more preferably not less than 2 H and most preferably not less than 3 H.

It is preferable that the medium and high refractive index layers in the present invention are formed in such a manner that a coating liquid containing a monomer or oligomer of an organic titanium compound represented by following Formula (1), or hydrolyzed products thereof are coated and subsequently dried, and the resulting refractive index is 1.55-2.5.

Ti(OR₁)₄ Formula (1)

where R₁ is an aliphatic hydrocarbon group having 1-8 carbon atoms, but is preferably an aliphatic hydrocarbon group having 1-4 carbon atoms. Further, in monomers or oligomers of organic titanium compounds or hydrolyzed products thereof, the alkoxide group undergoes hydrolysis to form a crosslinking structure via reaction such as —Ti—O—Ti, whereby a cured layer is formed.

Listed as prefered examples of monomers and oligomers of organic titanium compounds are dimers-decamers of Ti(OCH₃)₄, Ti(OC₂H₅)₄, Ti(O-n-C₃H₇)₄, Ti(O-i-C₃H₇)₄, Ti(O-n-C₄H₉)₄, and Ti(O-n-C₃H₇)₄, and dimers-decamers of Ti(O-n-C₄H₉)₄. These may be employed singly or in combination of at least two types. Of these, particularly preferred are dimers-decamers of Ti(O-n-C₃H₇)₄, Ti(O-i-C₃H₇)₄, Ti(O-n-C₄H₉)₄, and Ti(O-n-C₃H₇)₄.

The content of monomers and oligomers of organic titanium compounds, as well as hydrolyzed products thereof is preferably 50.0-98.0% by weight with respect to solids incorporated in the liquid coating composition. The solid ratio is more preferably 50-90% by weight, but is still more preferably 55-90% by weight. Other than these, it is preferable to incorporate polymers of organic titanium compounds (which are subjected to hydrolysis followed by crosslinking) in a liquid coating composition, or to incorporate titanium oxide particles. The high refractive index and medium refractive index layers in the present invention may incorporate metal oxide particles as particles and further may incorporate binder polymers.

In the above method of preparing a coating liquid, when hydrolyzed/polymerized organic titanium compounds and metal oxide particles are combined, both strongly adhere to each other, whereby it is possible to obtain a strong coating layer provided with hardness and flexibility in evenly coated layer.

The refractive index of metal oxide particles employed in the high and medium refractive index layers is preferably 1.80-2.80, but is more preferably 1.90-2.80. The weight average diameter of the primary particle of metal oxide particles is preferably 1-150 nm, is more preferably 1-100 nm, but is most preferably 1-80 nm. The weight average diameter of metal oxide particles in the layer is preferably 1-200 nm, is more preferably 5-150 nm, is still more preferably 10-100 nm, but is most preferably 10-80 nm. Metal oxide particles at an average particle diameter of at least 20-30 nm are determined employing a light scattering method, while the particles at a diameter smaller than 20-30 nm are determined employing electron microscope images. The specific surface area of metal oxide particles is preferably 10-400 m²/g as a value determined employing the BET method, is more preferably 20-200 m²/g, but is most preferably 30-150 m²/g.

Examples of metal oxide particles are metal oxides containing at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in percent by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferable that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

A ratio of metal oxide particles in the high and medium refractive index layers is preferably 5-65% by volume, more preferably 10-60% by volume and still more preferably 20-55% by volume.

The above-described metal oxide particles are supplied to a coating liquid, which forms a high refractive index layer, in a state of dispersion being dispersed in a medium. As a dispersion medium of metal oxide particles, preferable is a liquid having a boiling point of 60-170° C. Specific examples of a dispersion medium include water, alcohol (such as methanol, ethanol, isopropanol, butanol and benzylalcohol), ketone (such as acetone, methyl ethyl ketone, methyl isobutyl ketone and cyclohexanone), ketone alcohol (such as diacetone alcohol), ester (such as methyl acetate, ethyl acetate, propyl acetate, butyl acetate, methyl formate, ethyl formate, propyl formate and butyl formate), aliphatic hydrocarbon (such as hexane and cyclohexane), hydrocarbon halogenide (such as methylene chloride, chloroform and carbon tetrachloride), aromatic hydrocarbon (such as benzene, toluene and xylene), amide (such as dimethylformamide, dimethylacetamide and n-methylpyrrolidone), ether (such as diethyl ether, dioxane and tetrahydrofuran) and ether alcohol (such as 1-methoxy-2-propanol). Among them, toluene, xylene, methyl ethyl ketone, methyl isobutyl ketone, cyclohexanone and butanol are specifically preferable.

Further, metal oxide particles can be dispersed in a medium by use of a homogenizer. Examples of a homogenizer include a sand grinder mill (for example, a beads mill equipped with a pin), a high speed impeller mill, a baffle mill, a roller mill, an atliter and a colloidal mill. A sand grinder mill and a high speed impeller mill are specifically preferable. Further, a preliminary dispersion may be performed. Examples of a homogenizer utilized in a preliminary dispersion include a ball mill, a three-roll mill, a kneader and an extruder.

In a high refractive index layer and a medium refractive index layer, polymer having a cross-linked structure (hereinafter, also referred to as cross-linked polymer) is preferably utilized as binder polymer. Examples of cross-linked polymer include cross-linked compounds of polymer provided with a saturated hydrocarbon chain such as polyolefin (hereinafter, generally referred to as polyolefin), polyether, polyurea, polyurethane, polyester, polyamine, polyamide and melamine resin. Among them preferable are cross-linked compounds of polyolefin, polyether and polyurethane, more preferable are cross-linked compounds of polyolefin and polyether, and most preferably are cross-linked compounds of polyolefin.

In the present invention, examples of monomer having at least two ethylenic unsaturated group include ester of polyhydric alcohol and (meth)acrylic acid (such as ethyleneglycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate and polyester polyacrylate), vinylbenzene and derivatives thereof (such as 1,4-divinylbenzene, 4-vinylbenzoic acid-2-acryloyl ethylester, and 1,4-divinylcyclohexanone), vinyl sulfone (such as divinyl sulfone), acrylamide (such as methylene bisacrylamide) and methacrylamide. As monomer having an anionic group and monomer having an amino group or a quaternary ammonium group, monomer available on the market may be utilized. Monomer having an anionic group which is available on the market and preferably utilized includes Kayamar PM-21 and PM-2 (manufactured by Nippon Kayaku Co., Ltd.); Antox MS-60, MS-2N and MS-NH4 (manufactured by Nippon Nyukazai Co., Ltd.); Anilox M-5000, M-6000 and M-8000 series (manufactured by Toagosei Co., Ltd.); Viscoat #2000 series (manufactured by Osaka Organic Chemical Industry Ltd.); Newfrontier GX-8289 (manufactured by Dai-Ichi Kogyo Seiyaku Co., Ltd.); NK Ester CB-1 and A-SA (manufactured by Shin-Nakamura Chemical Co., Ltd.); and AR-100, MR-100 and MR-200 (manufactured by Dai-Hachi Chemical Industry Co., Ltd.). Further, monomer having an amino group or a quaternary ammonium group which is available on the market and preferably utilized includes DMAA (manufactured by Osaka Organic Chemical Industry Ltd.); DMAEA and DMAPAA (manufactured by Kohjin Co., Ltd.); Blemer QA (manufactured by Nippon Oil & Fat Co., Ltd.); and NewFrontier C-1615 (manufactured by Dai-Ichi Kogyo Seiyaku Co., Ltd.).

As a polymerization reaction of polymer, a photopolymerization reaction or a thermal polymerization reaction can be utilized and the former is specifically preferable. A polymerization initiator is preferably utilized. A polymerization initiator includes the above-described thermal polymerization initiator and photopolymerization initiator utilized to form binder polymer of a hard coat layer.

As a polymerization initiator, those available on the market may be utilized. A polymerization accelerator may be utilized in addition to a polymerization initiator. The addition amount of a polymerization initiator and a polymerization accelerator is preferably in the range of 0.2-10 weight % based on the total amount of monomer.

Added to each of the anti-reflection layers or the coating liquid compositions thereof may be polymerization inhibitors, leveling agents, thickeners, anti-coloring agents, UV absorbents, silane coupling agents, antistatic agents, and adhesion providing agents, other than the foregoing components such as metal oxide particles, polymers, dispersion media, polymerization initiators and polymerization accelerators.

In order to accelerate hydrolysis or curing of a composition containing metal alkoxide, irradiation of actinic radiation is preferable, after coating a medium or high refractive index layer in the present invention, or a low refractive index layer. Exposure to actinic radiation each time a layer is coated is more preferable. Ultraviolet rays, electron beams and γ rays are usable as the actinic rays. There is no restriction to the type of the energy source for applying the actinic energy radiation, as far as it activates the compound, however, preferably usable is ultraviolet rays or electron beams. Ultraviolet rays are specifically preferred since handling is easy and a high level of energy can be easily obtained. Any light source capable of generating the ultraviolet ray can be used as the light source of the ultraviolet ray for causing photo-polymerization of ultraviolet ray reactive compound. For example, it is possible to use the low voltage mercury lamp, intermediate voltage mercury lamp, high voltage mercury lamp, extra-high voltage mercury lamp, carbon arc light, metal halide lamp and xenon lamp. Further, the ArF excimer laser, KrF excimer laser, excimer lamp and synchrotron radiation can also be used. The conditions on irradiation differs according to each type. The preferred amount of irradiation is 20-10,000 mJ/cm². The more preferred amount is 100-2000 mJ/cm², and still more preferred amount is 400-2000 mJ/cm².

### EXAMPLES

In the following, specific effects of the present invention will be shown referring to examples to manufacture cellulose ester film which is an optical film provided with a clear hard coat layer and an antireflection layer by utilizing an extrusion head described in FIG. 2 according to the flow described in FIG. 4, however, an embodiment of the present invention is not limited thereto.

### Example 1

(Preparation of Cellulose Ester Film Having been Provided with Clear Hard Coat Layer)

(Preparation of Cellulose Ester Film)

Various types of additive solutions and a dope described in the following were prepared and a knurling treatment of 10 mm wide and 10 μm high was provided on the both edges of film, whereby long length and wide width cellulose ester film having a width of 1,200 mm, a length of 2,500 m and a thickness of 80 μm was prepared. 5 rolls of the prepared cellulose ester film were spliced with a connecting tape to make a total length of 12,500 m.

(Preparation at Silicon Oxide Dispersion A)

| | |
|---|---|
| Aerosil R972V (manufactured by Nippon Aerosil Co., Ltd.) | 1 kg |
| Ethanol | 9 kg |

The above composition, after having been mixed with stirring for 30 minutes by a dissolver, was subjected to dispersion by use of a Manton-Gaulin type high pressure homogenizer to prepare silicon oxide dispersion A.

<Preparation of Additive Solution B>

| | |
|---|---|
| Cellulose Triacetate (substitution degree of acetyl group: | 6 kg |
| 2.88) | |
| Methylene chloride | 140 kg |

The above composition was charged in a closed vessel, having been completely dissolved while being heated and stirred, and was filtered. The above-descried silicon oxide dispersion A of 10 kg was added thereto with stirring, the resulting solution was filtered after further stirring for 30 minutes, whereby additive solution B was prepared.

<Preparation of Dope C>

| | | |
|---|---|---|
| Methylene chloride | 440 | kg |
| Ethanol | 35 | kg |
| Cellulose triacetate (substitution degree of acetyl group: | 100 | kg |
| 2.88) | | |
| Triphenyl phosphate | 10 | kg |
| Ethylphthalyl ethylglycolate | 2 | kg |
| Tinuvin 326 (manufactured by Ciba Specialty Chemicals) | 0.3 | kg |
| Tinuvin 109 (manufactured by Ciba Specialty Chemicals) | 0.5 | kg |
| Tinuvin 171 (manufactured by Ciba Specialty Chemicals) | 0.5 | kg |

The above-described solvents were charged in a closed vessel, remaining materials being charged with stirring, and the resulting solution was completely dissolved and mixed with heating and stirring. The solution was cooled to a temperature of dope casting and allowed standing for one night, and the solution, after having been subjected to a defoaming operation, was filtered by use of Azumi Filter Paper No. 244 manufactured by Azumi Filter Paper Co., Ltd. Further, the above-described solution was added with 3 kg of additive solution B to be mixed with an inline mixer (Static Inline Mixer Hi-Mixer SWJ, produced by Toray Industries, Inc.), and the resulting solution was filtered to prepare dope C.

Dope C, after having been filtered, was uniformly cast on a stainless band support of 35° C. at a dope temperature of 35° C. Thereafter, after the dope having been dried on a support, film was peeled off from a stainless band support. The residual solvent amount of the film at this time was 80%. The film, after having been peeled off from a stainless band support, was dried in a drying zone kept at 80° C. for 1 minute, followed by being stretched by 0.98 times in the longitudinal direction and by 1.1 times in the width direction under an atmosphere of 100° C. by use of a biaxial stretching tenter when the residual solvent amount was 3-10 weight%, and then the width holding was released and the film was dried in a drying zone of 125° C. while being transported with many rolls, whereby aimed cellulose ester film was prepared.

<Preparation of Clear Hard Coat Layer Coating liquid>

| | |
|---|---|
| Dipentaerythritol hexaacrylate | 100 weight parts |
| Photoreaction initiator (Irgacure 184, manufactured | 4 weight parts |
| by Ciba Specialty Chemicals) | |
| Propyleneglycol monomethylether | 75 weight parts |
| Methyl ethyl ketone | 75 weight parts |

These materials were mixed to prepare a clear hard coat layer coating liquid.

<Formation of Clear Hard Coat Layer>

The prepared clear hard coat layer coating liquid was coated on the one surface of the prepared cellulose ester film (having a total length of 12,500 m) by use of an extrusion head according to the flow of S1-S6 described in FIG. 4, while changing the state of supplying solvent to the vicinity of an ejecting portion of a coating liquid in extrusion head from a solvent supply means as indicated in table 1, whereby samples Nos. 101-114 each of was prepared for 12,400 m, respectively. Coating was performed under coating conditions; a transport speed of 30 m/min, a coating width of 1,000 mm, a wet layer thickness of 10 μm and the narrowest gap between an extrusion head and cellulose ester film of 80 μm; and thereafter the coated layer was dried by eliminating the residual solvent at a drying temperature of 120° C., followed by being cured by ultraviolet irradiation at an irradiation strength of 150 mJ/cm² in a curing zone and cooled to room temperature. Herein, acetone was utilized as a solvent which was supplied to the vicinity of an ejecting portion of a coating liquid in an extrusion head from a solvent supply means. The supply amount of the solvent from a solvent supply means is represented by the ratio (%) of the supply amount of the solvent based on the supply amount of a coating liquid. Namely, when the same amount of a solvent as the supply amount of a coating liquid is supplied, the supply amount of the solvent is 100%.

Evaluation

With respect to prepared each sample Nos. 101-114, a good product length calculated by eliminating uneven coating (streak defects, spot defects), which can be visually recognized, is shown in table 1.

TABLE 1

| | State of | State of | | | | | |
|---|---|---|---|---|---|---|---|
| | solvent | solvent | | State of | | | |
| | supply | supply from | State of | solvent | | | |
| | when | immediately | solvent | supply when | | | |
| | coating | before start | supply when | ejection of | | | |
| | liquid is | coating | extrusion | coating | | | |
| | ejected | until | head is | liquid from | | | |
| | from | immediately | moved away | extrusion | Supply | | |
| | extrusion | after start | from film to | head is | amount | Length | |
| | head (sate | coating | be coated | stopped | of | of good | |
| Sample | of S1–S2 | (state of S3 | (state of S5 | (state of S6 | solvent | product | |
| No. | of FIG. 4) | of FIG. 4) | of FIG. 4) | of FIG. 4) | (%) | (m) | Remarks |
| 101 | *1 | *1 | *1 | *1 | 10 | 12100 | Invention |
| 102 | *1 | *1 | *1 | *1 | 50 | 12200 | Invention |
| 103 | *1 | *1 | *1 | *1 | 100 | 12200 | Invention |
| 104 | *1 | *1 | *1 | *1 | 150 | 12300 | Invention |
| 105 | *1 | *1 | *1 | *1 | 300 | 12200 | Invention |
| 106 | *1 | *1 | *1 | *1 | 150 | 12300 | Invention |
| 107 | *1 | *2 | *1 | *1 | 150 | 10100 | Invention |
| 108 | *1 | *1 | *2 | *1 | 150 | 8300 | Invention |
| 109 | *1 | *2 | *2 | *1 | 150 | 7500 | Invention |
| 110 | *2 | *1 | *1 | *1 | 150 | 10700 | Invention |
| 111 | *2 | *2 | *1 | *1 | 150 | 7100 | Invention |
| 112 | *2 | *1 | *2 | *1 | 150 | 8000 | Invention |
| 113 | *2 | *2 | *1 | *1 | 150 | 9600 | Invention |
| 114 | *2 | *2 | *2 | *2 | 0 | 5800 | Comparison |

*1: Solvent supplied,
*2: No supply of solvent

The effectiveness of the present invention has been confirmed.

### Example 2

Using the same material as sample No. 104 of example 1, coating was intentionally interrupted to stop transfer of a film to be coated at the time of having coated 6200 m under the same condition, and further ejection of a coating liquid was stopped for 1 hour. In the case of not supplying a solvent to the vicinity of an ejecting portion of an extrusion head meanwhile, it required 35 minutes after restart of coating until obtaining a coated film without uneven coating (streak defects, spot defects) which can be visually recognized. On the other hand, solvent was supplied to the vicinity of an extrusion head ejecting portion at a amount of 150%, thereafter ejection of a coating liquid being stopped, coating was restarted after continuous solvent supply during 1 hour stop, whereby it required only 5 minutes until obtaining a coated film without uneven coating (streak defects, spot defects) which can be visually recognized. The effectiveness of the present invention has been confirmed.

### Example 3

### Preparation of Cellulose Ester Film Having Been Provided with Clear Hard Coat Layer

(Preparation of Cellulose Ester Film)

Cellulose ester film was prepared by utilizing the same material and under the same condition as example 1. 5 rolls of prepared cellulose ester film were spliced with a connecting tape to make a total length of 12,500 m.

<Formation of Clear Hard Coat Layer>

On the one surface of the prepared cellulose ester film (having a total length of 12,500 m) a clear hard coat layer coating liquid, which is same as example 1, was coated 4 times according to the flow indicated by S1-S6 in FIG. 4 by use of an extrusion head while varying the state of solvent supply to the vicinity of an ejecting portion of a coating liquid in an extrusion head as shown in table 2 to prepare sample Nos. 301-303. Herein, four times refers to repeat the operation, in which an extrusion head is returned to the waiting position and ejection of a coating liquid is stopped after coating of a total length of 12,500 m, then the extrusion head is returned to the coating position from the waiting position after 1 hour to coat a total length of 12,500 m again, four times. The coating was performed under the same conditions as example 1. Herein, as a solvent which is supplied to the vicinity of an ejecting portion of a coating liquid in an extrusion head from a solvent supply means, acetone was utilized. The supply amount of the solvent from a solvent supply means is represented by the ratio (%) of the supply amount of the solvent based on the supply amount of a coating liquid.

Evaluation

With respect to prepared each sample Nos. 301-303, a good product length calculated by eliminating uneven coating (streak defects, spot defects), which can be visually recognized, is shown in table 2.

TABLE 2

| | State of | State of | | | | | |
|---|---|---|---|---|---|---|---|
| | solvent | solvent | | State of | | | |
| | supply | supply from | State of | solvent | | | |
| | when | immediately | solvent | supply when | | | |
| | coating | before start | supply when | ejection of | | | |
| | liquid is | coating | extrusion | coating | | | |
| | ejected | until | head is | liquid from | | | |
| | from | immediately | moved away | extrusion | Supply | | |
| | extrusion | after start | from film to | head is | amount | Length | |
| | head (sate | coating | be coated | stopped | of | of good | |
| Sample | of S1–S2 | (state of S3 | (state of S5 | (state of S6 | solvent | product | |
| No. | of FIG. 4) | of FIG. 4) | of FIG. 4) | of FIG. 4) | (%) | (m) | Remarks |
| 301 | Solvent | Solvent | Solvent | Solvent | 100 | 48800 | Invention |
| | supplied | supplied | supplied | supplied | | | |
| 302 | Solvent | Solvent | Solvent | No supply of | 100 | 37820 | Invention |
| | supplied | supplied | supplied | solvent | | | |
| 303 | No supply | No supply of | No supply of | No supply of | 0 | 17980 | Comparison |
| | of solvent | solvent | solvent | solvent | | | |

The effectiveness of the present invention has been confirmed.

### Example 4

<Preparation of Cellulose Ester Film Having Been Coated with Clear Hard Coat Layer/Low Refractive Index Layer>

Cellulose ester film of a total length of 12,400 m, which is same as one prepared in example 1, was prepared and a clear hard coat layer of 12,300 m long was formed under the same condition as that of sample-No. 104. Thereafter, the low refractive index layer coating liquid described below was coated on a clear hard coat layer by use of an extrusion head shown in FIG. 2 according to the flow shown in FIG. 4 varying the supplying state to supply a solvent to the vicinity of an ejecting portion of a coating liquid in an extrusion head as shown in table 2, whereby sample Nos. 401-414 were prepared, each of which was prepared for 12,200 m, respectively. Coating was performed under coating conditions; a transport speed of 30 m/min, a coating width of 1,000 mm, a wet layer thickness of 10 μm and the narrowest gap between an extrusion head and cellulose ester film of 70 μm; and thereafter the coated layer was dried by eliminating the residual solvent at a drying temperature of 120° C., followed by being cured by ultraviolet irradiation at an irradiation strength of 300 mJ/cm² in a curing zone and cooled to room temperature. Herein, as a solvent which is supplied to the vicinity of an ejecting portion of a coating liquid in an extrusion head from a solvent supply means, acetone was utilized. The supply amount of the solvent from a solvent supply means is represented by the ratio (%) of the supply amount of the solvent based on the supply amount of a coating liquid.

<Low Refractive Index Layer Coating liquid>

| | | |
|---|---|---|
| Hydrolyzed product of tetraethoxysilane* | 27 | g |
| γ-methacryloxypropyl trimethoxysilane | 0.8 | g |
| Aluminum trisethylacetoacetate | 0.8 | g |
| 2% acetone dispersion of silica micro-particles | 30 | ml |
| (ultrasonic dispersion) (Product name: Aerosil 200, | | |
| manufactured by Nippon Aerosil Co., Ltd.)) | | |
| Cyclohexanone | 50 | ml |
| Fluorine type surfactant (Megafac F-172, | 0.1 | g |
| manufactured by Dainippon Ink & Chemicals, Inc.) | | |

*Preparation Method of Hydrolyzed Product of Tetraethoxysilane: Tetraethoxysilane of 250 g was added with 380 g of ethanol, and a hydrochloric acid solution, in which 3 g of hydrochloric acid (12 N) had been dissolved in 235 g of water, was gradually titrated at room temperature. After titration, the resulting solution was stirred for 3 hours at room temperature.

Evaluation

With respect to prepared each sample Nos. 401-414, a good product length calculated by eliminating uneven coating (streak defects, spot defects), which can be visually recognized, is shown in table 3.

TABLE 3

| | State of | State of | | | | | |
|---|---|---|---|---|---|---|---|
| | solvent | solvent | | State of | | | |
| | supply | supply from | State of | solvent | | | |
| | when | immediately | solvent | supply when | | | |
| | coating | before start | supply when | ejection of | | | |
| | liquid is | coating | extrusion | coating | | | |
| | ejected | until | head is | liquid from | | | |
| | from | immediately | moved away | extrusion | Supply | | |
| | extrusion | after start | from film to | head is | amount | Length | |
| | head (sate | coating | be coated | stopped | of | of good | |
| Sample | of S1–S2 | (state of S3 | (state of S5 | (state of S6 | solvent | product | |
| No. | of FIG. 4) | of FIG. 4) | of FIG. 4) | of FIG. 4) | (%) | (m) | Remarks |
| 401 | *1 | *1 | *1 | *1 | 10 | 12000 | Invention |
| 402 | *1 | *1 | *1 | *1 | 50 | 12100 | Invention |
| 403 | *1 | *1 | *1 | *1 | 100 | 12100 | Invention |
| 404 | *1 | *1 | *1 | *1 | 150 | 12200 | Invention |
| 405 | *1 | *1 | *1 | *1 | 300 | 12100 | Invention |
| 406 | *1 | *1 | *1 | *1 | 150 | 12200 | Invention |
| 407 | *1 | *2 | *1 | *1 | 150 | 10200 | Invention |
| 408 | *1 | *1 | *2 | *1 | 150 | 8000 | Invention |
| 409 | *1 | *2 | *2 | *1 | 150 | 7700 | Invention |
| 410 | *2 | *2 | *2 | *1 | 150 | 10500 | Invention |
| 411 | *2 | *1 | *1 | *1 | 150 | 6900 | Invention |
| 412 | *2 | *2 | *1 | *1 | 150 | 7900 | Invention |
| 413 | *2 | *1 | *2 | *1 | 150 | 9500 | Invention |
| 414 | *2 | *2 | *2 | *2 | 0 | 5500 | Comparison |

*1: Solvent supplied,
*2: No supply of solvent

The effectiveness of the present invention has been confirmed.

### Example 5

Using the same material as sample No. 404 of example 4, coating was intentionally interrupted to stop transfer of a film to be coated at the time of having coated 6150 m under the same condition, and further ejection of a coating liquid was stopped for 1 hour. In the case of not supplying a solvent to the vicinity of an ejecting portion of an extrusion head meanwhile, it required 35 minutes after restart of coating until obtaining a coated film without uneven coating (streak defects, spot defects) which can be visually recognized. On the other hand, solvent was supplied to the vicinity of an extrusion head ejecting portion at a amount of 150%, thereafter ejection of a coating liquid being stopped, coating was restarted after continuous solvent supply during 1 hour stop, whereby it required only 5 minutes until obtaining a coated film without uneven coating (streak defects, spot defects) which can be visually recognized. The effectiveness of the present invention has been confirmed.

### Example 6

<Preparation of Cellulose Ester Film Having Been Coated with Clear Hard Coat Layer/Low Refractive Index Layer>

Cellulose ester film of a total length of 12,400 m, which is same as one prepared in example 1, was prepared and a clear hard coat layer of 12,300 m long was formed under the same condition as that of sample No. 104. Thereafter, the low refractive index layer coating liquid same as example 4 was coated 4 times on a clear hard coat layer by use of an extrusion head shown in FIG. 2 according to the flow shown in S1-S6 of FIG. 4 varying the supplying state to supply a solvent to the vicinity of an ejecting portion of a coating liquid in an extrusion head as shown in table 4, whereby sample Nos. 601-603 were prepared. Herein, four times refers to repeat the operation, in which an extrusion head is returned to the waiting position and ejection of a coating liquid is stopped after coating of a total length of 12,300 m, then the extrusion head is returned to the coating position from the waiting position after 1 hour to coat a total length of 12,300 m again, four times. The coating was performed under the same conditions as example 4. Herein, as a solvent which is supplied to the vicinity of an ejecting portion of a coating liquid in an extrusion head from a solvent supply means, acetone was utilized. The supply amount of a solvent from a solvent supply means is represented by the ratio (%) of the supply amount of the solvent based on the supply amount of a coating liquid.

Evaluation

With respect to prepared each sample Nos. 601-603, a good product length calculated by eliminating uneven coating (streak defects, spot defects), which can be visually recognized, is shown in table 4.

TABLE 4

| | State of | State of | | | | | |
|---|---|---|---|---|---|---|---|
| | solvent | solvent | | State of | | | |
| | supply | supply from | State of | solvent | | | |
| | when | immediately | solvent | supply when | | | |
| | coating | before start | supply when | ejection of | | | |
| | liquid is | coating | extrusion | coating | | | |
| | ejected | until | head is | liquid from | | | |
| | from | immediately | moved away | extrusion | Supply | | |
| | extrusion | after start | from film to | head is | amount | Length | |
| | head (sate | coating | be coated | stopped | of | of good | |
| Sample | of S1–S2 | (state of S3 | (state of S5 | (state of S6 | solvent | product | |
| No. | of FIG. 4) | of FIG. 4) | of FIG. 4) | of FIG. 4) | (%) | (m) | Remarks |
| 601 | Solvent | Solvent | Solvent | Solvent | 100 | 48000 | Invention |
| | supplied | supplied | supplied | supplied | | | |
| 602 | Solvent | Solvent | Solvent | No supply of | 100 | 37510 | Invention |
| | supplied | supplied | supplied | solvent | | | |
| 603 | No supply | No supply of | No supply of | No supply of | 0 | 17050 | Comparison |
| | of solvent | solvent | solvent | solvent | | | |

The effectiveness of the present invention has been confirmed.

What is claimed is:

1. A method to produce a coated film comprising the steps of:
(a) ejecting a coating liquid continuously from an ejecting portion of an extrusion head;
(b) applying the coating liquid ejected from the ejecting portion of the extrusion head onto a continuously conveyed film; and
(c) stopping the ejection of the coating liquid, wherein
an organic solvent is supplied to a vicinity of the ejecting portion of the extrusion head from before starting the ejection of the coating liquid to after starting the ejection of the coating liquid in step (a).

2. The method of claim 1, wherein
the organic solvent is supplied to the vicinity of the ejecting portion of the extrusion head from before stopping the ejection of the coating liquid to after stopping the ejection of the coating liquid in step (c).

3. The method of claim 1, wherein
the organic solvent is supplied to the vicinity of the ejecting portion of the extrusion head from before starting the ejection of the coating liquid in step (a) to after starting the application of the coating liquid onto the continuously conveyed film in step (b).

4. The method of claim 1 further comprising the step of:
(d) moving the extrusion head away from the continuously conveyed film while the coating liquid is continuously ejected from the ejecting portion of the extrusion head.

5. The method of claim 4, wherein
the organic solvent is supplied to the vicinity of the ejecting portion of the extrusion head from before step (d) to after step (d).

6. The method of claim 4, subsequent to step (d), further comprising the step of:
(e) moving the extrusion head again to start applying the coating liquid onto the continuously conveyed film.

7. The method of claim 6, wherein
the organic solvent is supplied to the vicinity of the ejecting portion of the extrusion head from before step (d) to after step (e).

8. The method of claim 1, after step (c), further comprising the step of:
(f) ejecting the coating liquid continuously again from the ejecting portion of the extrusion head.

9. The method of claim 8, wherein
the organic solvent is supplied to the vicinity of the ejecting portion of the extrusion head from before stopping the ejection of the coating liquid in step (c) to after starting the ejection of the coating liquid again in step (f).

10. A method to produce a coated film comprising the sequential steps of:
(a) ejecting a coating liquid continuously from an ejecting portion of an extrusion head;
(b) applying the coating liquid ejected from the ejecting portion of the extrusion head onto a continuously conveyed film; and
(c) stopping the ejection of the coating liquid, wherein
an organic solvent is supplied to a vicinity of the ejecting portion of the extrusion head from before stopping the ejection of the coating liquid to after stopping the ejection of the coating liquid in step (c).

11. The method of claim 10 further comprising the step of:
(d) moving the extrusion head away from the continuously conveyed film while the coating liquid is continuously ejected from the ejecting portion of the extrusion head.

12. The method of claim 11, wherein
the organic solvent is supplied to the vicinity of the ejecting portion of the extrusion head from before step (d) to after step (d).

13. A method to produce a coated film comprising the sequential steps of:
(a) ejecting a coating liquid continuously from an ejecting portion of an extrusion head;
(b) applying the coating liquid ejected from the ejecting portion of the extrusion head onto a continuously conveyed film;
(c) stopping the ejection of the coating liquid; and
(d) moving the extrusion head away from the continuously conveyed film while the coating liquid is continuously ejected from the ejecting portion of the extrusion head,
wherein
an organic solvent is supplied to a vicinity of the ejecting portion of the extrusion head from before step (b) to after step (d).

14. A coated film produced by the method of claim 1.

15. A coated film produced by the method of claim 10.

16. A coated film produced by the method of claim 13.
